(19) United States
(12) Patent Application Publication
(10) Pub. No.: US 2009/0213443 A1
(43) Pub. Date: Aug. 27, 2009

(54) Apparatus and method for encoding or/and decoding digital hologram

(75) Inventors: Hoon-Jong Kang, Daejeon (KR); Dae-Hee Kim, Daejeon (KR); Kug-Jin Yun, Daejeon (KR); Chung-Hyun Ahn, Daejeon (KR); Soo-in Lee, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 11/887,068

(22) PCT Filed: Sep. 28, 2005
(86) PCT No.: PCT/KR2005/003218

§ 371 Date: Feb. 11, 2009

(30) Foreign Application Priority Data
Mar. 25, 2005 (KR) 10-2005-0024788

(51) Int. Cl. G03H 1/16

(52) U.S. Cl. 359/29

(57) ABSTRACT

Provided is an apparatus for encoding and/or decoding a digital hologram. The apparatus for encoding a digital hologram includes: a segmentation unit for dividing a digital hologram inputted from an external device into a plurality of blocks; an orthogonal transforming unit for orthogonally transforming each of the divided blocks; a quantization unit for quantizing information of each of the transformed blocks; a scanning unit for scanning each of the quantized blocks to transform the plurality of the quantized blocks to single moving image sequence; and a moving image encoding unit for encoding the single moving image sequence configuring a digital hologram to compress the signal moving image sequence.

### TECHNICAL FIELD

The present invention relates to a digital hologram processing technique and more particular to an apparatus and method for encoding or/and decoding a digital hologram.

### BACKGROUND ART

According to development of digital image industry, a high definition television (HDTV) was developed to provide high quality images for satisfying visual sensation of human. Furthermore, various three dimensional (3-D) displaying methods have been developed to display images three-dimensionally. Such a three dimensional image displaying method is classified whether a 3-D glass is required to wear or not when a viewer watches a three-dimensional image. Recently, there are many studies in progress to develop a three dimensional image displaying method not requiring such a 3-D glass and giving no fatigue to a viewer although a viewer watches a three-dimensional image for long time without wearing the 3-D glass.

A representative three-dimensional displaying method satisfying the above condition is a holography method. The holography method has been widely known as an ideal method for displaying three-dimensional image.

A term “hologram” is combined with a “HOLOS” which means “Whole” in Greek and a “GRAM” which means “message” in Greek. The hologram is obtained by flattening information of three-dimension image. That is, three-dimension information is flattened to two-dimensional information, and the two-dimensional information is reproduced to three-dimensional image. That is, the hologram is displaying of object's three-dimensional property which is formed of wave surfaces of light reflected from the object using coherency of light. A hologram denotes recording of the three-dimensional property of an object in two-dimensional film. A holography denotes displaying of the three-dimensional property of an object in three-dimensions.

A hologram is different from a picture. It is possible to form an astral world in an identical hologram as like as watching an object through a microscope. Also, an image can be reproduced in an empty space by the hologram. Furthermore, natural colors of spectrum can be reproduced through the hologram. However, the hologram has shortcomings. That is, a high-density hologram film must be used for generating a hologram because the hologram is a picture taking technique recording coherent waves of light. Also, the hologram must be created or reproduced as single color image since coherent patterns are recorded. Furthermore, the hologram is embodied as a still image only.

Recently, a computer generated hologram (CGH) is developed as a method for creating, storing, transmitting and image-processing a hologram using a computer. And, there are also many other methods in progress for obtaining a digital hologram using a high definition charge coupled device (CCD) instead of a holographic film, and storing, transmitting and displaying the obtained digital hologram.

However, it is very difficult to store and transmit the CGH or digital holograms obtained through the CCD because such a digital hologram includes mass amount of information compared to original three-dimensional object.

### DISCLOSURE

### Technical Problem

It is, therefore, an object of the present invention to provide an apparatus and method for encoding or/and decoding a digital hologram to reduce an amount of information of the digital hologram.

It is another object of the present invention to provide an apparatus and method for decoding an encoded digital hologram.

It is still another object of the present invention to provide an apparatus and method for encoding a digital hologram to reduce an amount of information of the digital hologram, and decoding the encoded digital hologram.

### Technical Solution

In accordance with one aspect of the present invention, there is provided an apparatus for encoding a digital hologram including: a segmentation unit for dividing a digital hologram inputted from an external device into a plurality of blocks; an orthogonal transforming unit for orthogonally transforming each of the divided blocks; a quantization unit for quantizing information of each of the transformed blocks; a scanning unit for scanning each of the quantized blocks to transform the plurality of the quantized blocks to single moving image sequence; and a moving image encoding unit for encoding the single moving image sequence configuring a digital hologram to compress the signal moving image sequence.

In accordance with another aspect of the present invention, there is provided an apparatus for decoding a digital hologram including: a moving image decoding unit for decoding an encoded digital hologram inputted from an external device to convert the encoded digital hologram to single moving image sequence; a inverse-scanning unit for performing a inverse-scanning operation on the single moving image sequence to arrange each of blocks to corresponding locations; a inverse-quantization unit for performing a inverse-quantization operation on each of the inverse-scanned blocks; a inverse-orthogonal transforming unit for inverse-orthogonal transforming each of the quantized blocks; and a inverse-segmentation unit for performing a inverse-segmentation operation on each of the inverse-transformed blocks to merge the plurality of inverse-transformed blocks to single digital hologram.

In accordance with still another aspect of the present invention, there is provided an apparatus for encoding/decoding a digital hologram including: a segmentation unit for dividing a digital hologram inputted from an external device into a plurality of blocks; an orthogonal transforming unit for orthogonally transforming each of the divided blocks; a quantization unit for quantizing information of each of the transformed blocks; a scanning unit for scanning each of the quantized blocks to transform the plurality of the quantized blocks to single moving image sequence; a moving image encoding unit for encoding the single moving image sequence configuring a digital hologram to compress the signal moving image sequence; a moving image decoding unit for decoding the encoded digital hologram from the moving image encoding unit to convert the encoded digital hologram to single moving image sequence; a inverse-scanning unit for performing a inverse-scanning operation on the single moving image sequence to arrange each of blocks to corresponding locations; a inverse-quantization unit for performing a inverse-quantization operation on each of the inverse-scanned blocks; a inverse-orthogonal transforming unit for inverse-orthogonal transforming each of the quantized blocks; and a inverse-segmentation unit for performing a inverse-segmentation operation on each of the inverse-transformed blocks to merge the plurality of inverse-transformed blocks to single digital hologram.

In accordance with further another aspect of the present invention, there is provided a method for encoding a digital hologram in a digital hologram encoding apparatus including the steps of: a) dividing a digital hologram into a plurality of blocks having a predetermined size; b) orthogonal-transforming each of the divided blocks; c) quantizing each of information in the transformed blocks to computer-processable values; d) converting each of the quantized blocks to single moving image sequence by scanning each of the quantized blocks; and e) encoding the single moving image sequence configuring a digital hologram to compress the digital hologram.

In accordance with further still another aspect of the present invention, there is provided a method for decoding a digital hologram including the steps of: a) decoding an encoded digital hologram to single moving image sequence configuring a digital hologram; b) inverse-scanning the single moving image sequence to arrange each of blocks to corresponding locations; c) inverse-quantizing each of the inverse-scanned blocks; d) inverse-orthogonal transforming each of the inverse-quantized blocks; and e) inverse-segmenting each of the inverse-transformed blocks to merge the plurality of the inverse-transformed blocks to a digital hologram.

### Advantageous Effects

A mass amount of information in a digital hologram can be reduced by encoding and decoding a digital hologram obtained from three-dimensional object using a CGH generation algorithm or a digital hologram obtaining apparatus according to the present invention.

### DESCRIPTION OF DRAWINGS

The above and other objects and features of the present invention will become apparent from the following description of the preferred embodiments given in conjunction with the accompanying drawings, in which:

FIG. 1 is a block diagram illustrating an apparatus for encoding a digital hologram in accordance with a preferred embodiment of the present invention;

FIG. 2 is a block diagram showing an apparatus for decoding a digital hologram in accordance with a preferred embodiment of the present invention;

FIG. 3 shows a digital hologram created or obtained from an original object;

FIG. 4 shows a segmented digital hologram;

FIG. 5 shows a digital hologram obtained by orthogonally transforming a segmented digital hologram;

FIG. 6 is a graph for explaining a general linear quantization method;

FIG. 7 is block diagram for explaining a method of scanning an orthogonal-transformed image;

FIG. 8 shows a stream image created by scanning;

FIG. 9 is a block diagram for explaining another method of scanning an orthogonal-transformed image;

FIG. 10 is a flowchart of a method for encoding a digital hologram in accordance with a preferred embodiment of the present invention; and

FIG. 11 is a flowchart of a method for decoding a digital hologram in accordance with a preferred embodiment of the present invention.

### BEST MODE FOR THE INVENTION

Other objects and aspects of the invention will become apparent from the following description of the embodiments with reference to the accompanying drawings, which is set forth hereinafter.

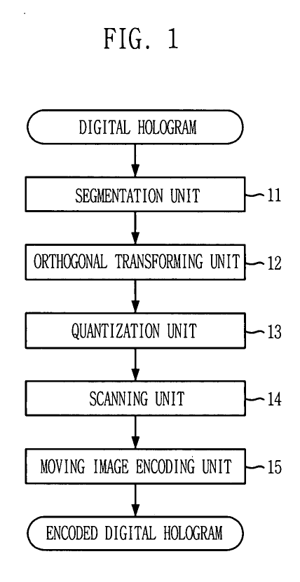

FIG. 1 is a block diagram illustrating an apparatus for encoding a digital hologram in accordance with a preferred embodiment of the present invention.

Referring to FIG. 1, the apparatus for encoding a digital hologram according to the present invention includes a segmentation unit 11 for segmenting a digital hologram inputted from an external device into a plurality of blocks; an orthogonal transforming unit 21 for orthogonally transforming the plurality of blocks; a quantization unit 13 for quantizing each of the transformed blocks in order to convent information of the each block, which is a floating point number, to a computer-processable value; a scanning unit 14 for converting each of the quantized blocks to single moving image sequence by scanning the quantized blocks; and a moving image encoding unit 15 for encoding the single moving image sequence configuring a digital hologram to compress the single moving image sequence.

Hereinafter, a detailed structure and operations of the apparatus for encoding a digital hologram will be described.

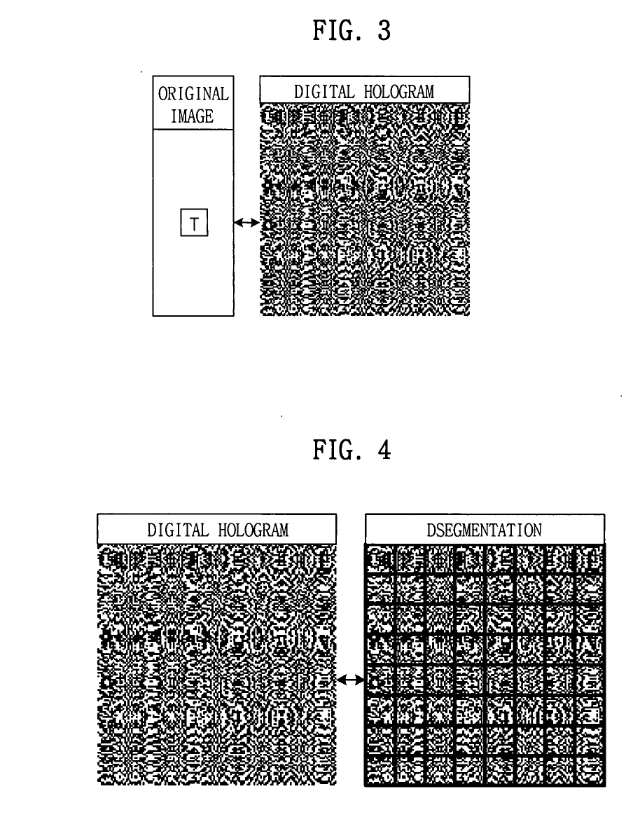

At first, a current digital hologram may be a computer generated hologram (CGH), or may be obtained through a high resolution charge coupled device (CCD). Furthermore, the current digital hologram may be obtained by any other methods. FIG. 3 shows a digital hologram created or obtained from a text “T” which is an original object. Since such a hologram contains a mass amount of information compared to the original three-dimensional object, it requires encoding the digital hologram to store and transmit the digital hologram.

It assumes that the digital hologram is created by a CGH generation algorithm or obtained from a digital hologram obtaining apparatus, and the digital hologram inputs to the segmentation unit 11.

The segmentation unit 11 receives the digital hologram and divides the received digital hologram into a plurality of blocks. That is, the segmentation unit 11 divides the digital hologram into the blocks each to have a predetermined size that provides a high encoding-efficiency of the digital hologram. As an example of the block size, FIG. 4 shows a digital hologram divided into 84 blocks of 8×8.

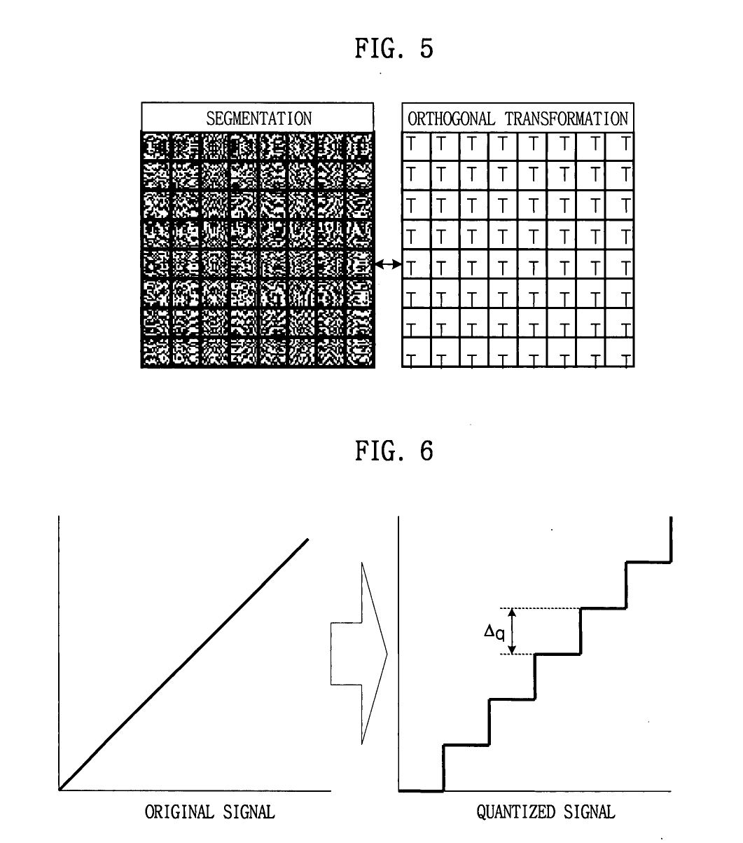

The orthogonal transforming unit 12 orthogonally transforms each of the divided blocks. That is, the orthogonal transforming unit 12 uses an orthogonal transforming function to transform the divided blocks. The orthogonal transforming function may be one of a discrete cosine transform (DCT), a fast fourier transform (FFT), a wavelet transform, a karhunen-loeve transform (KLT), a hadamard transform, a slant transform, a fresnel transform, and a fraunhofer transform. As a result of orthogonal transforming, three-dimensional images of the object are created. The created three-dimensional images are similar to watching the object from a location of each block. FIG. 5 shows the three-dimensional images obtained after the orthogonal transforming the segmented digital hologram. That is, FIG. 5 shows the result obtained after creating the digital hologram from the original object “T”, segmenting the digital hologram and orthogonal-transforming each of the segmented blocks. As shown in FIG. 5, the text “T” has patterns distributed in a vertical direction and a horizontal direction with respect to a center of the orthogonal-transformed image. Each of the patterns denotes an image shown to an observer from a location of corresponding block, and there is a disparity between the patterns, which is a shift path difference.

Each of the orthogonal-transformed blocks includes information of floating point value. The quantization unit 13 performs a quantization operation on each of the orthogonal-transformed blocks to transform information of floating point value to a value of the finite number processable to a computer. That is, information of the each block is expressed as a floating point value, and the quantization unit 13 quantizes the information to a computer-processable value such as an integer value or a natural number. Such information of the orthogonal-transformed block is converted through the quantization to information processable by a computer. FIG. 6 shows a general quantization scheme, and such a general quantization scheme can be used in the present invention.

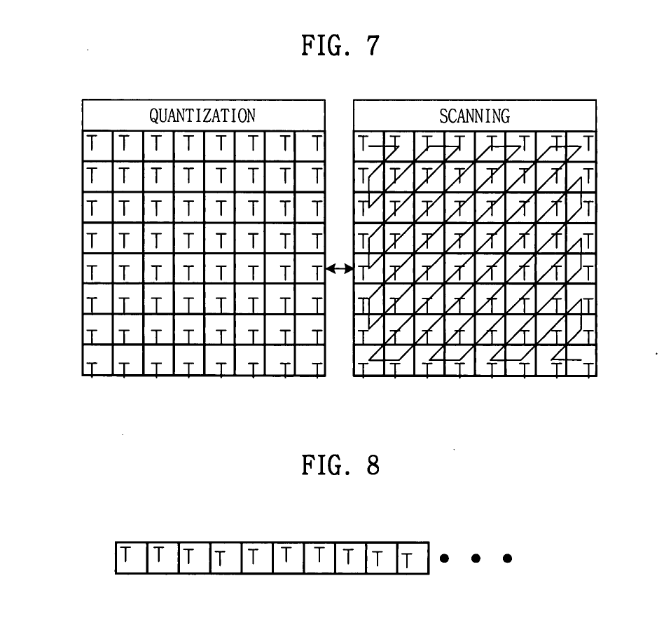

As described above, the apparatus for encoding a digital hologram according to the present invention is distinguished from a general encoding scheme. In order to clearly show the present invention, each of steps to encode the digital hologram according to the present invention is explained with referenced to FIGS. 3 to 5. However, there is not much difference shown in drawings showing results obtained before and after quantization although floating point data are converted to integer data by the quantization. That is, integer numbers must be shown in a left drawing of FIG. 7 instead of text “T” for showing a real result of the quantization. However, since it is very difficult to insert integer data on the drawing instead of text “T”, the text “T” is shown in FIGS. 7 to 9 instead of the integer data.

In order to approximates the floating point value of information to a finite value processable by a computer, the quantization unit 13 uses one of a linear scalar quantization method and a quantization table method. The linear scalar quantization method regularly performs a quantization operation according to a constant quantization step (∇q). The quantization table method performs the quantization operation according to quantization step defined in a quantization table.

The scanning unit 14 scans each of the quantized blocks for converting the quantized blocks to single moving image sequence. That is, the scanning unit 14 re-arranges the two-dimensionally arranged blocks to a one-dimension by scanning the blocks. As a result, the single moving image sequence is generated. That is, the scanning unit 14 generates a moving image stream by scanning the images of blocks.

As an example of scanning, a zig-zeg scanning or a Hilbert scanning may be used. Such a scanning method is shown in FIGS. 7 and 8. FIG. 7 shows a zig-zeg scanning performed on orthogonal transformed images in blocks in order to generate single moving image stream. FIG. 8 shows a moving image stream generated by the zig-zeg scanning.

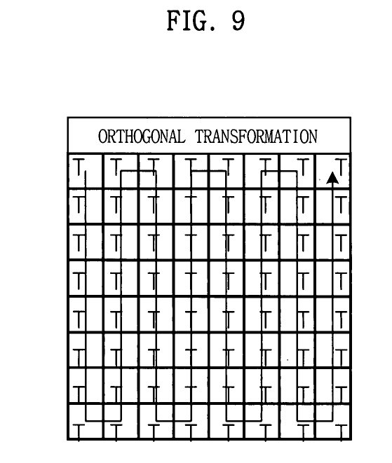

FIG. 9 shows another scanning method. As shown in FIG. 9, a scanning operation is alternatively performed on blocks of even rows in an upward direction and blocks of odd rows in a downward direction, respectively. Such a scanning method may reduce a size of shift or variation vector in the moving image encoding unit 15.

As further another scanning method, blocks of even columns and blocks of odd columns may be alternatively scanned in a right direction and a left direction, respectively. Such a scanning method may also reduce a size of shift or variation vector in the moving image encoding unit 15.

The moving image encoding unit 15 encodes the single moving image sequence configuring the digital hologram and outputs the encoded digital hologram. That is, the moving image encoding unit 15 uses a moving picture encoding algorithm such a MPEG to encode the blocks arranged in one dimension in order to compress the digital hologram.

As described above, the apparatus for encoding a digital hologram according to the present invention minimizes an amount of information included in the digital hologram by compressing the digital hologram through encoding the digital hologram.

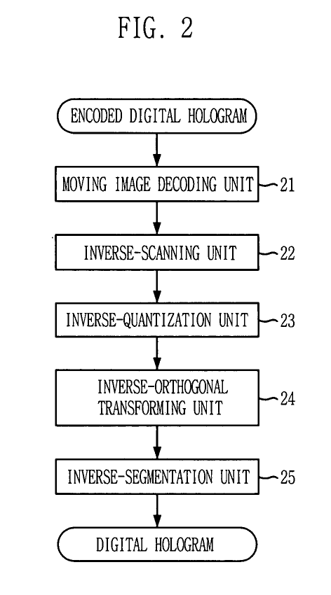

FIG. 2 is a block diagram showing an apparatus for decoding a digital hologram in accordance with a preferred embodiment of the present invention. The apparatus for decoding a digital hologram performs the operations of the apparatus for encoding shown in FIG. 1 in an inverse order.

As shown in FIG. 2, the apparatus for decoding a digital hologram according to the present invention includes: a moving image decoding unit 21 for receiving an encoded digital hologram from an external device, decoding the received digital hologram to single moving image sequence configuring the digital hologram; a inverse-scanning unit 22 for inverse-scanning the single moving image sequence to arrange each of blocks to corresponding locations; a inverse-quantization unit 23 for performing a inverse-quantization on each of the inverse-scanned blocks; a inverse-orthogonal transforming unit 24 for inverse-orthogonal transforming each of the quantized blocks to a plurality of blocks of the digital hologram; and a inverse-segmentation unit 25 for merging the plurality of the blocks to single digital hologram.

Hereinafter, a detailed structure and operations of the apparatus for decoding a digital hologram according to the present invention will be described.

An encoded digital hologram, which is encoded to reduce an amount of information, inputs to a moving image decoding unit 21. The encoded digital hologram may be stored in a memory or may be transferred to the moving image decoding unit 21 through a communication network.

The moving image decoding unit 21 uses a decoder prepared as a pair with an encoder of the moving image encoding unit 15 to decode contents configured with single stream. Herein, the moving image decoding unit 21 decodes an input stream to a single moving image sequence shown in FIG. 8 and outputs the single moving image sequence to the inverse scanning unit 22.

The inverse-scanning unit 22 converts images of blocks configured as the single moving image sequence shown in FIG. 8 to one image. That is, one-dimensionally arranged blocks are re-arranged in two-dimension blocks as shown in FIG. 7. The inverse-scanning unit 22 inversely performs scanning operations of the scanning unit 14. For example, if the scanning unit 14 scans blocks of odd rows from top to bottom and blocks of even rows from bottom to top, and performs the scanning operation from left up to right down, the inverse-scanning unit 22 performs the scanning operations from right down to left up, scans blocks of odd column from bottom to top, and scans blocks of even column from top to bottom.

By performing the inverse-scanning as described above, two-dimensional image is generated as shown in FIG. 7, and the two-dimensional image is transferred to the inverse-quantization unit 23.

The inverse-quantization unit 23 converts scales of each block information value. Each of blocks is configured with integer values, and the inverse-quantization unit 23 inversely performs the quantization operation of the quantization unit 13 on each of blocks. For example, a quantization step (∇q) of the quantization unit 13 is multiplied to each of the block to approximate the integer values of blocks to result values of the orthogonal transforming unit 12.

The inverse-orthogonal transforming unit 24 transforms each of the blocks to digital holograms. Herein, the inverse-orthogonal transforming unit 24 performs inverse function of an orthogonal transform function used in the orthogonal transforming unit 12.

The inverse-segmentation unit 25 converts the each of blocks to single digital hologram. That is, the inverse-segmentation unit 25 generates the digital hologram similar to an original image before encoding.

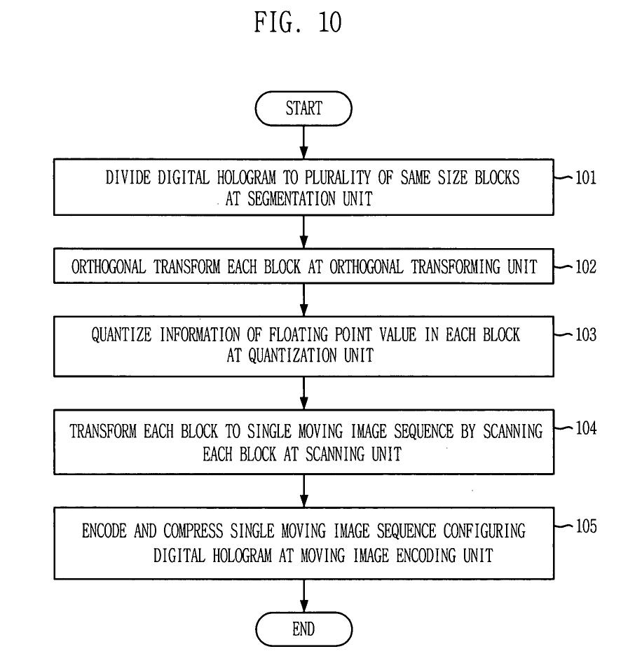

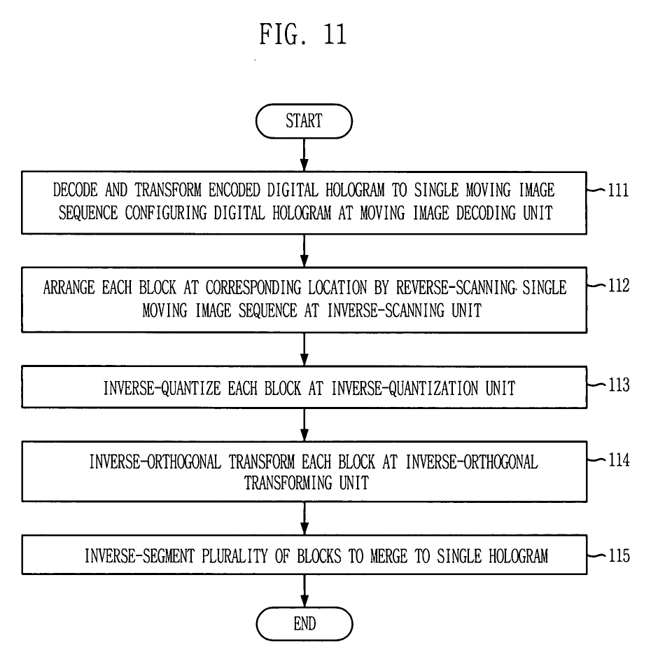

Hereinafter, operations of a method for encoding and/or decoding a digital hologram according to the present invention will be described with reference to FIGS. 10 and 11.

FIG. 10 is a flowchart of a method for encoding a digital hologram in accordance with a preferred embodiment of the present invention.

Referring to FIG. 10, the segmentation unit 11 divides a digital hologram into a plurality of blocks each to have a predetermined size at step S101.

The orthogonal transforming unit 21 orthogonal-transforms each of the divided blocks at step S102.

The quantization unit 13 performs a quantization on floating point values of information in each of the transformed blocks to computer-processable values at step S103.

The scanning unit 14 scans each of the quantized blocks to convert each of the quantized blocks to single moving image sequence at step S104.

The moving image encoding unit 15 encodes the single moving image sequence configuring a digital hologram in order to compress the digital hologram at step S105.

FIG. 11 is a flowchart of a method for decoding a digital hologram in accordance with a preferred embodiment of the present invention.

Referring to FIG. 11, the moving image decoding unit 21 decodes the encoded digital hologram to convert the encoded digital hologram to single moving image sequence at step S111.

The inverse-scanning unit 22 performs an inverse-scanning operation on the single moving image sequence to arrange each of blocks at corresponding locations at step S112.

The inverse-quantization unit 23 performs the inverse-quantization operation on each of the inverse-scanned blocks at step S113.

The inverse-orthogonal transforming unit 24 inverse-transforms the each of the inverse-quantized blocks at step S114.

The inverse-segmentation unit 25 performs the inverse-segmentation operation to merge a plurality of inverse-transformed blocks to single digital hologram at step S115.

Meanwhile, the apparatus for encoding a digital hologram and the apparatus for decoding a digital hologram may be combined as one system for encoding/decoding a digital hologram. Furthermore, the method for encoding a digital hologram and the method for decoding a digital hologram may be embodied in one system.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The present application contains subject matter related to Korean patent application No. 2005-0024788, filed with the Korean Intellectual Property office on Mar. 25, 2005, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. An apparatus for encoding a digital hologram, the apparatus comprising:
a segmentation means for dividing a digital hologram inputted from an external device into a plurality of blocks;
an orthogonal transforming means for orthogonally transforming each of the divided blocks;
a quantization means for quantizing information of each of the transformed blocks;
a scanning means for scanning each of the quantized blocks to transform the plurality of the quantized blocks to single moving image sequence; and
a moving image encoding means for encoding the single moving image sequence configuring a digital hologram to compress the signal moving image sequence.

2. The apparatus as recited in claim 1, wherein the segmentation means divides the digital hologram to the plurality of blocks each to have a predetermined size providing high encoding-efficiency of a digital hologram.

3. The apparatus as recited in claim 2, wherein the orthogonal transforming means uses one of orthogonal transformation functions including a discrete cosine transform (DCT), a fast fourier transform (FFT), a wavelet transform, a karhunen-loeve transform (KLT), a hadamard transform, a slant transform, a fresnel transform and a fraunhofer transform to perform the orthogonal transforming.

4. The apparatus as recited in claim 3, wherein the quantization means uses a linear scalar quantization method performing a quantization operation according to a constant quantization step (∇q) or a quantization method using a quantization step defined by a quantization table in order to transform a floating point value of information in each of the orthogonal transformed blocks to a value of the finite number which is processable by a computer.

5. The apparatus as recited in claim 1, wherein the scanning means uses one of a zig-zeg scanning method, a Hilbert scanning method and an alternative scanning method for alternatively scanning blocks of odd rows from bottom to top and scanning blocks of even rows from top to bottom or alternatively scanning blocks of odd columns from left to right and scanning blocks of even columns from right to left in order to covert each of the blocks to single moving image sequence.

6. An apparatus for decoding a digital hologram, the apparatus comprising:
a moving image decoding means for decoding an encoded digital hologram inputted from an external device to convert the encoded digital hologram to single moving image sequence;
an inverse-scanning means for performing an inverse-scanning operation on the single moving image sequence to arrange each of blocks to corresponding locations;
an inverse-quantization means for performing an inverse-quantization operation on each of the inverse-scanned blocks;
a inverse-orthogonal transforming means for inverse-orthogonal transforming each of the quantized blocks; and
an inverse-segmentation means for performing an inverse-segmentation operation on each of the inverse-transformed blocks to merge the plurality of inverse-transformed blocks to single digital hologram.

7. An apparatus for encoding/decoding a digital hologram, the apparatus comprising:
a segmentation means for dividing a digital hologram inputted from an external device into a plurality of blocks;
an orthogonal transforming means for orthogonally transforming each of the divided blocks;
a quantization means for quantizing information of each of the transformed blocks;
a scanning means for scanning each of the quantized blocks to transform the plurality of the quantized blocks to single moving image sequence;
a moving image encoding means for encoding the single moving image sequence configuring a digital hologram to compress the signal moving image sequence;
a moving image decoding means for decoding the encoded digital hologram from the moving image encoding means to convert the encoded digital hologram to single moving image sequence;
an inverse-scanning means for performing an inverse-scanning operation on the single moving image sequence to arrange each of blocks to corresponding locations;
an inverse-quantization means for performing an inverse-quantization operation on each of the inverse-scanned blocks;
an inverse-orthogonal transforming means for inverse-orthogonal transforming each of the quantized blocks; and
an inverse-segmentation means for performing an inverse-segmentation operation on each of the inverse-transformed blocks to merge the plurality of inverse-transformed blocks to single digital hologram.

8. The apparatus as recited in claim 7, wherein the segmentation means divides the digital hologram to the plurality of blocks each to have a predetermined size providing high encoding-efficiency of a digital hologram.

9. The apparatus as recited in claim 8, wherein the orthogonal transforming means uses one of orthogonal transformation functions including a discrete cosine transform (DCT), a fast fourier transform (FFT), a wavelet transform, a karhunen-loeve transform (KLT), a hadamard transform, a slant transform, a fresnel transform and a fraunhofer transform to perform the orthogonal transforming.

10. The apparatus as recited in claim 7, wherein the scanning means uses one of a zig-zeg scanning method, a Hilbert scanning method and an alternative scanning method for alternatively scanning blocks of odd rows from bottom to top and scanning blocks of even rows from top to bottom or alternatively scanning blocks of odd columns from left to right and scanning blocks of even columns from right to left in order to covert each of the blocks to single moving image sequence.

11. A method for encoding a digital hologram in a digital hologram encoding apparatus, the method comprising:
a) dividing a digital hologram into a plurality of blocks having a predetermined size;
b) orthogonal-transforming each of the divided blocks;
c) quantizing each of information in the transformed blocks to computer-processable values;
d) converting each of the quantized blocks to single moving image sequence by scanning each of the quantized blocks; and
e) encoding the single moving image sequence configuring a digital hologram to compress the digital hologram.

12. The method as recited in claim 11, wherein in the step a), the digital hologram is divided into blocks each to have a size providing high encoding-efficiency of a digital hologram.

13. The method as recited in claim 12, wherein in the step b), the orthogonal transforming is performed by using one of orthogonal transformation functions including a discrete cosine transform (DCT), a fast fourier transform (FFT), a wavelet transform, a karhunen-loeve transform (KLT), a hadamard transform, a slant transform, a fresnel transform and a fraunhofer transform to perform the orthogonal transforming.

14. The method as recited in claim 11, wherein in the step d), the scanning is performed by using one of a zig-zeg scanning method, a Hilbert scanning method and an alternative scanning method for alternatively scanning blocks of odd rows from bottom to top and scanning blocks of even rows from top to bottom or alternatively scanning blocks of odd columns from left to right and scanning blocks of even columns from right to left in order to covert each of the blocks to single moving image sequence.

15. A method for decoding a digital hologram, the method comprising the steps of:
a) decoding an encoded digital hologram to single moving image sequence configuring a digital hologram;
b) inverse-scanning the single moving image sequence to arrange each of blocks to corresponding locations;
c) inverse-quantizing each of the inverse-scanned blocks;
d) inverse-orthogonal transforming each of the inverse-quantized blocks; and
e) inverse-segmenting each of the inverse-transformed blocks to merge the plurality of the inverse-transformed blocks to a digital hologram.
